(19) United States
(12) Patent Application Publication
(10) Pub. No.: US 2013/0054708 A1
(43) Pub. Date: Feb. 28, 2013

(54) SYSTEMS AND METHODS FOR SUGGESTING A TOPIC IN AN ONLINE GROUP

(71) Applicants: Rushi P. BHATT, Surat (IN); Kishor BARMAN, Navy Nagar (IN)

(72) Inventors: Rushi P. BHATT, Surat (IN); Kishor BARMAN, Navy Nagar (IN)

(73) Assignee: Yahoo! Inc., Sunnyvale, CA (US)

(21) Appl. No.: 13/221,473

(22) Filed: Aug. 30, 2011

(51) Int. Cl. G06F 15/16

(52) U.S. Cl. 709/206

(57) ABSTRACT

Systems and methods for suggesting a thread in an online group is disclosed. The method includes the following steps. First, the system calculates an average in-reply time to each user in the online group on history data. Second, the system calculates an average out-reply time from each user in the online group on history data. Third, the system identifies, in a computer, a root message in the thread by a first author. Fourth, the system identifies a second message in the thread that follows the root message. Fifth, the system determines an estimated growth rate of the thread based on average in-reply time and average out-reply time of the first author and a time delay between the second message and the root message. Finally, the system suggests the thread to users in the online group according to the estimated growth rate of the thread.

### BACKGROUND

Online communication is getting more and more popular recently with the help of different social network websites and online discussion boards. In these social network websites and online discussion boards, people may join different online groups based on their own individual interests and backgrounds.

These online groups are important channels of social interaction that facilitate topic-specific discussions among their members. Online groups tend to fill the gap between person-to-person social channels like email and Instant Messenger (IM), and mass-broadcast channels like Twitter and Facebook. To help the group members to communicate with each other more conveniently, it is helpful to suggest the most appropriate online topic to individual group member that fits the group member's individual interest.

People have studied the interactions between online group members and proposed a few models. Some of these models are based on purely structure and recency based local rules. Nonetheless, the existing models fail to provide a reliable solution to suggesting a topic to online group members accurately.

### SUMMARY

In this disclosure, we use the q-exponential distribution as a parametric fit for individual groups and show that a mix of individual q-exponentials gives rise to the familiar power-law like time to reply distributions. We also find a strong correlation between the arrival time delay of the first reply to thread-initiating messages and the ultimate size of the thread. Large threads usually start well! This is quite unexpected in the light of preferential attachment models which do not address this observation, but instead attach higher probabilities of replies to threads that have already become large. Using regression analysis, we identify correlates of participation and reply frequency modulations of individual users. The identity of the user posting the original messages correlates better with thread growth than the identity of users replying to the messages. Finally, we adopt a generative model by including processes that fit observed time to reply distributions. The generative model address the temporal characteristics of conversations observed here.

One embodiment discloses a computer implemented method or program for suggesting a thread in an online group. The computer implemented method is implemented by a computer system and includes the following steps. First, the computer system calculates an average in-reply time to each user in the online group on history data. Second, the computer system calculates an average out-reply time from each user in the online group on history data. Third, the computer system identifies a root message in the thread by a first author. Fourth, the computer system identifies a second message in the thread that follows the root message. Fifth, the computer system determines an estimated growth rate of the thread based on average in-reply time and average out-reply time of the first author and a time delay between the second message and the root message. Finally, the computer system suggests the thread to users in the online group according to the estimated growth rate of the thread. The computer implemented method or program may be stored in any computer-readable storage medium accessible by the computer system.

Another embodiment discloses a computer system having a processor configured to fit a first regression for a probability of an return of a user to thread based on a plurality of social properties of the user and fit a second regression for a probability of an increase or decrease in activity of the user to thread based on the plurality of social properties of the user and a social property of a parent author. The processor first determines a likelihood of joining the thread based on the first regression. The processor then determines a growth rate of the thread based on the second regression. The processor suggests the thread to users in the online group according to the estimated likelihood of joining and growth rate of the thread.

### BRIEF DESCRIPTION OF THE DRAWINGS

FIG. 1 illustrates a block diagram of one embodiment of an environment in which a system for suggesting a topic in an online group may operate;

FIG. 2 illustrates a tree model for messages in an online topic;

FIG. 3 illustrates the comparison of two correlation coefficients;

FIG. 4 is an illustration for a block diagram of a computer system for suggesting a thread in an online group;

FIG. 5(a) illustrates the average time to first reply to a root message vs. thread size in Group 1;

FIG. 5(b) illustrates the average time to first reply to a root message vs. thread size in Group 1;

FIG. 5(c) illustrates the average time to first reply to a root message vs. thread size in all groups;

FIG. 6 illustrates how messages with higher degree also generally have quicker first reply times;

FIG. 7(a) illustrates the relationship between the mean reply time and thread size in a first group;

FIG. 7(b) illustrates the relationship between the mean reply time and thread size in a second group;

FIG. 7(c) illustrates the relationship between the mean reply time and thread size in a third group; and

FIG. 7(d) illustrates the relationship between the mean reply time and thread size in a fourth group.

### DETAILED DESCRIPTION OF THE DRAWINGS

Online groups are an attractive way to study person-to-person discussions for the following reasons. Firstly, co-membership in groups signifies a commonality in user interest. For example, members of a UK Politics discussion group have presumably signed up because of their desire to discuss the topic. Secondly, messages have an unambiguous hierarchical relationship. Messages either start a new discussion thread, or are posted in reply to specific messages. Unique user identities are also associated with messages, making the construction of social relationship graphs convenient. Thirdly, group discussion threads have been shown to display unique structural characteristics like deep thread trees and a Heap's law like relationship for the number of unique authors in threads. Finally, as we will show in this disclosure, the inter-message reply time delays follow distributions that are quite dissimilar to those observed for inter-email reply times or for link creation in online blog posts.

Temporal dynamics of conversations have enjoyed a fair amount of scrutiny when it comes to person-to-person emails. A number of different models of communication have been proposed based on email data. Structure of conversation threads in online groups has also been studied recently. These studies propose generative models of how various temporal and structural characteristics of online conversations may be reconstructed by local interaction rules. A second line of research focuses on how social influence may affect information flow in social networks. This growing body of research attempts to identify the role of peer influence in information cascades.

In this disclosure, we study the temporal evolution of online group conversations using online groups and individual messages from the popular Yahoo! Groups product. We find that temporal evolution of threads has significant correlation with the past interaction between group members. Thus, generative models may not be sufficient to capture all aspects of online conversations. In this disclosure, we adopt a novel model that brings together the above two lines of research. The model is used to suggest online topics to group members accordingly.

Based on the temporal characteristics of online group threads in the data set, we find that the time to reply distributions are not uniformly power law and have strong circadian modulations. We adopt the q-exponential distribution as a parametric fit for individual groups and show that a mix of individual q-exponentials gives rise to the familiar power-law like time to reply distributions.

There is a strong correlation between the arrival time delay of the first reply to thread-initiating messages and the ultimate size of the thread. Popular threads usually start well. This is quite unexpected in the light of preferential attachment models which do not address this observation, but instead attach higher probabilities of replies to threads that have already become large.

Using regression analysis, we identify correlates of participation and reply frequency modulations of individual users. Apart from the expected factors like social relationship strength between participants, we find that the identity of the user posting the original messages correlates better with thread growth than the identity of users replying to the messages. In other words, it is about who starts the conversation more than who replies to the conversation. The generative model includes processes that fit observed time to reply distributions and addresses the temporal characteristics of conversations observed.

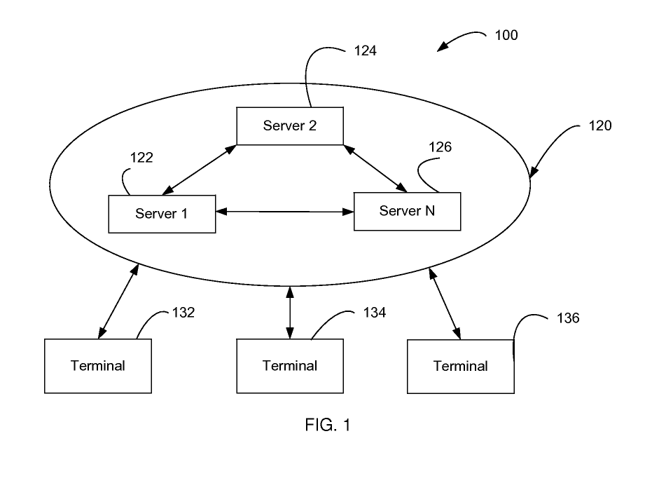

FIG. 1 is a block diagram of one embodiment of an environment in which a system for suggesting a topic in an online group may operate. However, it should be appreciated that the systems and methods described below are not limited to use with the particular embodiment.

The environment 100 may include a server system 120 communicating with a plurality of terminals 132, 134, and 136. The server system 120 includes a plurality of servers 122, 124 and 126. Each of the servers 122, 124 and 126 may be a computer, a server, or any other computing device known in the art. The plurality of servers 122, 124 and 126 may be a computer program, instructions, and/or software coda stored on a computer-readable storage medium that runs on a processor of a single server, a plurality of servers, or any other type of computing device known in the art. One of the servers 122, 124 and 126 may also be a virtual machine running a program that delivers content. One of the servers 122, 124 and 126 may be a search engine configured to help users find information located both inside and outside of the online group. One of the servers 122, 124 and 126 may be an advertisement server configured to provide digital ads to a web user based on display conditions requested by the advertiser. One of the servers 122, 124 and 126 may be a server configured to suggest a topic in an online group to the group members.

The group members may access the online group or other webpages using the plurality of terminals 132, 134, and 136. The plurality of terminals 132, 134, and 136 may be a computer, a smart phone, a personal digital aid, a digital reader, a Global Positioning System (GPS) receiver, or any other terminal that may be used to access the Internet. The number of group members in an online group may vary from group to group. For example, in Yahoo! groups, some group may have more than 1,000 members and some may only have about 20 members.

Generally, every group member has the right to post a new online message in the online group. For example, the group member creates a new discussion thread by posting the first online message in that thread. After a discussion thread is created, other group members may post reply messages in that discussion thread.

A discussion thread can be modeled by a tree model in graphic theory. A thread tree is constructed as follows. Any message that starts a conversation with a new subject and is not a reply to a previous posting in the same group is called the root message. Any subsequent replies in the thread are called child messages, and the message receiving a reply is the parent message. Each message has a unique message ID, a parent message ID (root messages have a parent ID of 0), an author ID signifying a unique Yahoo! Groups member, and a timestamp of when the message was posted. With this information, we construct the complete Groups graph, which is a collection of message threads belonging to various individual groups.

In this disclosure, we will use the following notation. Messages will be denoted by integer numbers or letters u, v, w, . . . . Authors of messages will be denoted by letters a, b, Parent-child relationships between messages u and v will be denoted by function v=parent(u) with message v being a parent of message u. Similarly, u=child(v) will denote u being a child of v. Each message u also has a timestamp t(u), originator author(u), and parent message originator parent author(u). Root nodes have null parent author. A parent message is always created before any of its child messages are created. Thus, if v=parent(u) then t(v)≦t(u).

The time to reply for a message u is calculated as r(v; u)=t(u)−t(v), where v=parent(u). Root messages have an undefined time to reply.

For a given thread T, authors(T) will denote the set of authors participating in T. We will also calculate co-authorship and other social relationships based on users participating in the same threads. Finally, the degree(u) of a message u is calculated as the total number of replies received by u.

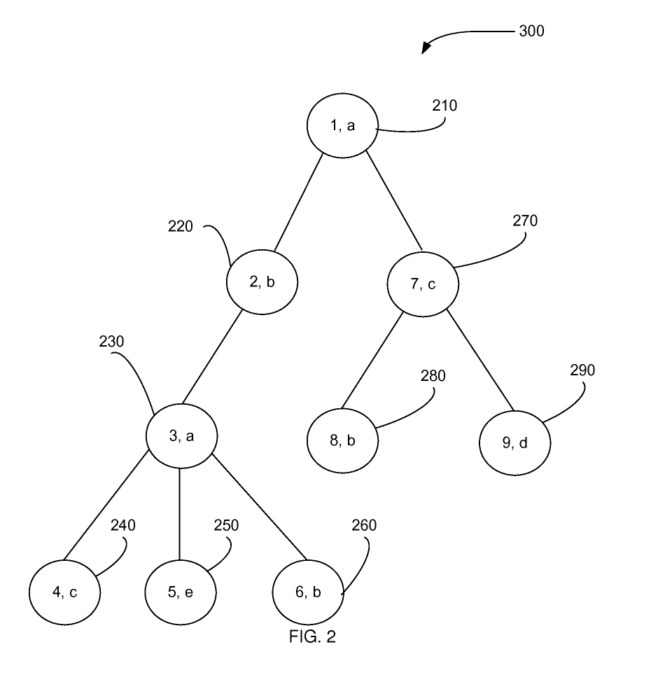

FIG. 2 illustrates an example of a discussion thread tree 200 created by a user ‘a’ posting a root message 210. In other words, the user ‘a’ is the author of the first message in the discussion thread 200. After the root message 210 is posted by the user ‘a,’ a user ‘b’ replies to the root message 210 by posting a second message 220. The user ‘a’ replies to the message 220 by posting a third message 230. Users ‘b,’ ‘c,’ and ‘e’ all reply to the message 230 by respectively posting messages 240, 250, and 260. Similarly, user ‘c’ also replies to the root message 210 by posting a message 270. Users ‘b’ and ‘d’ reply to the message 270 by respectively posting messages 280 and 290.

In the discussion thread tree 200, the author of the root message 210 is the parent author of the authors of messages 220 and 270. In other words, the user ‘a’ is the parent author of the users ‘b’ and ‘c.’ At the same time, because messages 240, 250, and 260 are replies to the message 230, the user ‘a’ is also the parent author of the users ‘c,’ ‘e,’ and ‘b.’

In the thread illustrated in FIG. 2, authors(T) includes five authors ‘a,’ ‘b,’ ‘c,’ ‘d,’ and ‘e.’ The author ‘a’ posts two messages. The author ‘b’ post three messages. The author ‘c’ posts two messages. Either author ‘d’ or ‘e’ posts only one message in the thread. Each message v with parent u has a time to reply r(u; v) which is the time difference between when message u was posted and when a reply v to u was posted.

The example in FIG. 2 can also be used to illustrate how author and parent baselines are computed. Here, parent baseline is the mean of the in-reply times, which is the average of all the reply times of the replies to the parent author. Author baseline is the mean of the out-reply times, which is the average of all the reply times of the replies to the author. As illustrated in FIG. 2, parent baseline of the author ‘a’ equals mean(r(1,2), r(1,7), r(3,4), r(3,5), r(3,6)) and author baseline of author ‘b’ equals mean(r(1,2), r(7,8), r(3,6)). While only a single thread is illustrated in FIG. 2, we may compute parent baseline and author baseline using all threads in the group. The different threads may be weighted according to their content, creating time, or other factors.

Returning to computation of the correlation coefficients, we compute two correlation coefficients for a group G as follows. First, we correlate the time to reply with the baseline posting rates of authors of replies, called the author baseline. Specifically, for each message pair (parent(v); v) posted in group G we compute Pearson's correlation coefficient Ra(G) between quantities r(parent(v); v) and author baseline(author(v)). Second, we correlate the time to reply with the average rate at which a given user's posts receive replies, called the parent baseline. In other words, we compute Pearson's correlation coefficient Rp(G) between r(parent(v); v) and parent baseline(parent author(v)).

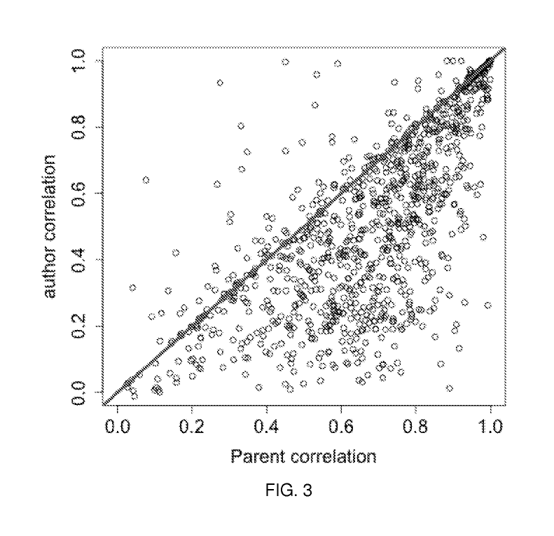

FIG. 3 illustrates the comparison of these two correlation coefficients as a scatter plot. The horizontal axis represents correlation of reply times to the parent author's baseline out-reply times (historical), and the vertical axis represents correlation of reply times to the author's (child's) baseline in-reply time. The solid line is of unit slope which denotes equal correlation to parent and author. We see that, for the same group, correlation with parent authors' out-reply time is generally higher than the authors' in-reply time: Close to 85% of the groups lie below the diagonal in FIG. 3, meaning parents authors' baseline time to receiving replies correlates better with the time to reply than reply authors' baseline time to writing replies. Thus, we use the parent authors' baseline time to predict the time to reply in a thread.

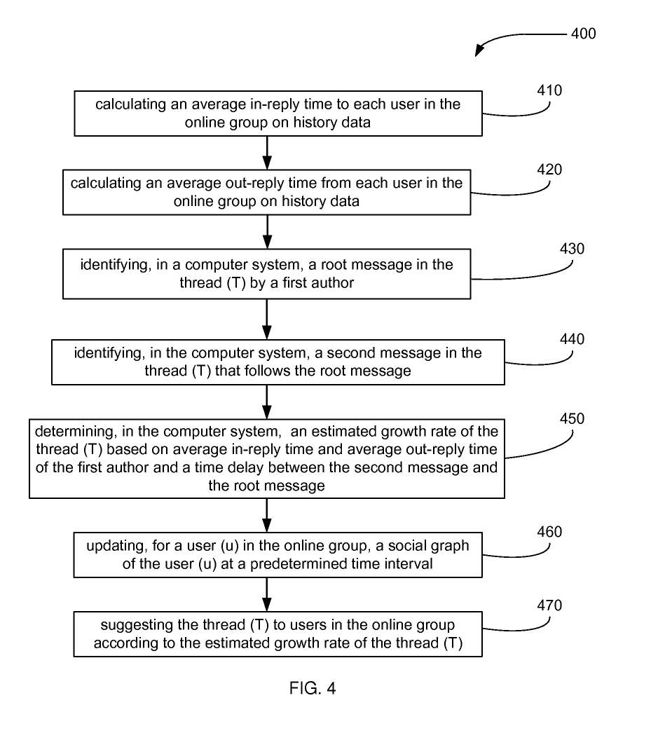

FIG. 4 is a block diagram 400 of a computer system for suggesting a thread (T) in an online group. The computer system includes computers with processors and computer readable media such as hard disk, computer memory, or other data storage hardware. A user may access the computer system on a mobile device such as a smart phone, a tablet, an internet ready TV, or any other device that can access internet. A′computer implemented method in the computer system may include the following steps. Other steps may be added or substituted.

In step 410, the computer system calculates an average in-reply time to each user in the online group on history data. In step 420, the computer system calculates an average out-reply time from each user in the online group on history data. In these two steps, the history data may include the historical participation of each user in a predetermined time period. The history data may be weighted differently according its age. For example, recent data may be weighted more than relatively old data.

In step 430, the computer system identifies a root message in the thread (T) by a first author. The computer system may further identify keywords in the root message based on the title of the thread (T) and the content of the root message.

In step 440, the computer system identifies a second message in the thread (T) that follows the root message. The computer system may further identify whether the second message is related to the root message by comparing their content and keywords.

In step 450, the computer system then determines an estimated growth rate of the thread (T) based on average in-reply time and average out-reply time of the first author and a time delay between the second message and the root message.

In step 460, the computer system suggests the thread (T) to users in the online group according to the estimated growth rate of the thread (T). For example, for each user in the online group, the computer system may first determines a likelihood of joining the thread (T) based on a plurality of social properties of the user and then suggests the thread if the determined likelihood is greater than a preset value. Similarly, the computer system may determine a plurality of likelihoods of joining a plurality of threads based on a plurality of social properties of the user and suggest the top N threads accordingly. Here, N is a positive integer configured by the computer system or the user. Additionally, the computer system may determine the plurality of likelihoods of joining a thread based on a plurality of overall online behavior.

For an online group, a user social graph is modeled as a directed graph GS=(V;E) with vertex set V as the set of users in the online group who have posted at least once, and the edge weight e_{ab} between two users a, bεV as the number of times a has replied to b in the past. Lack of any messaging between users indicates an edge weight of 0 and thus lack of an edge. The graph evolves as new users begin posting and as new messages are posted. The social graph is updated at a predetermined time interval. We then use the social graph at time t to fit the regression of whether a user replies to any of the thread messages posted up to time t.

The plurality of social properties of a user (a) includes at least one of the following: degree(a) that relates to the total number of replies by the user (a), social_degree(a, T) that relates to the total number of replies by the user (a) in the thread (T), no_of_neighbors(a,T) that relates to the number of neighbors of the user (a) in the thread (T), thread_size(T) that relates to the number of messages in the thread (T), and weight_last_author(a, T) that relates to an edge between the user (a) and the author who posted the last message in the thread (T). We may also use overall online behavior such as the overall online activity level of each user. For example, how frequently the user views Yahoo! pages. The overall online behavior may be measured using the number of web pages visited, frequency of visit, and inter-visit time differences.

For an author in the thread (T), the computer system may further determines a likelihood of increase or decrease in activity based on a first plurality of social properties of the author and a second plurality of social properties of an author of a parent message. The first and second plurality of social properties may include the above listed social properties based on the social graph at time t.

After the social graph is updated, the computer system may then calculate at least one of the following social variables based on the social graph at time (t) for thread (T). Weight_last_author(a, T) equals an edge weight of the edge between the user (a) and an author who posted the last message in the thread T. Degree(a) equals total number of replies by the user (a) in the online group. Social_degree(a, T) equals total number of replies by the user (a) to all authors currently present in the thread (T). No_of_neighbors(a,T) equals number of authors present in the thread (T) that the user (a) has replied at least once in the past. Thread_size(T) equals total number of messages in the thread.

For the online group, we fit a first regression for a probability of a return of the user (a) to thread (T) based on the plurality of social properties of the user (a). We may also fit a second regression for a probability of an increase or decrease in activity of the user (a) to thread (T) based on the plurality of social properties of the user (a) and a social property of a parent author. For example, the social property of the parent author may include a ratio of the parent author's mean in-reply time to the parent author's mean out-reply time. The probability of author a replying to an existing thread T is denoted by P(a; T). We fit a logistic-linear function

$$log ( \frac{P ( a , T )}{1 - P ( a , T )} ) = {β}_{0} + {\sum }_{i} {β}_{i} {x}_{i} , \qquad ( 1 )$$

where P is the probability that user (a) returns to thread T in the online group. The social properties used for the regression fit are described in Table 1. The first five variables in Table 1 are used for this regression fit. Last column contains the change in deviance residuals when variable described in the row is excluded for the regression. The two numbers are for the P(reply) regression that fits re-posting in the same thread, and P(longer) regression that fits the probability of elongation of time to reply.

As mentioned above, all input features to logistic regression were computed on the fly; to fit the probability that user ‘a’ returns to thread T at time t, we only use activities up to t. This reduces the target variable to a binary outcome: Either user (a) posts at time t at thread T, or a does not participate in T anymore. We thus create a dataset where each post by user counts as a positive example, and upon observing the last post in a thread we create a negative example for each of the participants in the thread.

TABLE 1

| | | Devi- | Devi- |
|---|---|---|---|
| | | ance | ance |
| | | P | P |
| Variable | Description | (reply) | (longer) |
| degree(a) | Total number of replies | 4% | 2% |
| | by the author a in that | | |
| | group. | | |
| thread_size(T) | Total number of | 33% | 3.5% |
| | messages in the thread | | |
| social_degree(a, T) | Total number of replies | 1% | 1% |
| | by the author a to the set | | |
| | of authors currently | | |
| | present in the thread T. | | |
| no_of_neighbors(a, T) | Number of authors | 6% | 6% |
| | present in the thread T, | | |
| | to whom a has replied at | | |
| | least once in the past. | | |
| weight_last_author(a, T) | Weight of the edge | 2% | 5.7% |
| | between a and the author | | |
| | who posted the last | | |
| | message in the thread T. | | |
| parent to child baseline | parent(a)'s baseline out- | Not | 15% |
| ratio(a) | reply time to that of | avail- | |
| | author a's baseline in- | able | |
| | reply time | | |

In an online group, weight_last_author(a, T) and social_degree(a, T) have strong positive effect on return probability for most of the groups. In other words, users tend to post more when their social connections have already participated in the thread. On the other hand, factors other than the average user activity level matter more while predicting re-posting probabilities. About 80% of groups have negative coefficients values for thread size. This confirms the fact that already large threads are unlikely to grow further. We also looked at percent increase in deviance residuals) of models fit with one feature left out at a time. Percentage increase in deviance residuals when each variable is left out at a time are summarized in Table 1, in column titled Deviance P(reply). Deviance analysis confirms that weight last author and social degree are more informative than no of neighbors. That is, the strength of relationship between already-participating authors encourages further participation.

We now turn to the question of what factors are related to whether an author will post a message quicker than expected given that we know she will post. For the purpose of this analysis, we assume that we know every participating author's baseline determined according to FIG. 2. Relative to this baseline rate, we try to predict if the author will reply quicker or slower. Similarly, the problem can be framed as a regression and fit the probability of the author taking longer than her individual baseline reply rate. We use all six variables in Table 1 as inputs to regression. The regression may include different models such as logistic regression, general linear regression, non linear regression, or conditional random field.

In the history data, parent to child baseline ratio has a significant positive correlation. That is, for a message pair (parent(u); u), a low baseline ratio makes it more likely that user a, who writes message u, will take longer than her overall posting frequency. A low value of the parent to child baseline ratio also indicates that parent author(u) tends to receive replies quicker than the rate at which author(u) generates replies. In short, parent message author being “popular” has more bearing on authors replying quicker than the overall structural attributes or the baseline reply rates of authors.

A TI-model assumes a process where, for each discrete step i, either a thread stops growing with some probability, or a message u is probabilistically chosen to receive a reply v. In the TI-model, the probabilistic rule is a function of how recently u was posted and the number of existing replies, or degree, of u. This construction fits the observed power law like distributions in thread replies well. In order to fit the Heaps' law observed in the data, another rule selects whether one of the authors already participating in the threads posts u or a randomly selected user from all group members posts the reply. Although the TI-model utilizes the recency of messages while attaching replies, it does not explain the q-exponential time to reply distributions we because in the TI-model messages arrive at a fixed rate. As a result, time to reply distributions follow the same power law distributions as the thread degree distributions.

Human communication patterns have been modeled as inhomogeneous Poisson processes. q-exponentials arise naturally as mixtures of exponential distributions like the Poisson distribution when the Poisson arrival rate parameter β is distributed as a X² distribution.

More global results also exist. If Γ is a Gamma distributed random variable with shape parameter α and scale parameter β, and if X is an exponential distributed with rate parameter γ˜Γ(α,β) (i.e., With E(X)=γ⁻¹, then the unconditional distribution of X is Pareto (i.e., a power law distribution) with shape parameter α and scale parameter β.

With the above two results in mind, it is plausible that the heavy tailed distributions observed in time to reply over the whole dataset may be due to a continuous mixture of exponentially distributed individual times to reply. The q-exponential like times to replies may be a consequence of a mixture of Poisson processes due to individual users. Furthermore, when all groups are combined the overall time to reply distribution resembles a Pareto like heavy tailed distribution.

We use a variable arrival rate for the messages as follows. Suppose we are in an online group G, and a reply u is to be attached to a message v according to the TI-model. We assume that the time stamp t(u) is chosen such that t(u)−t(v) is q-exponentially distributed with parameters qG and kG. Observing the distributions of q-exponential parameters, we assume that the shape parameters qG and scale parameters kG are Gamma and power law distributed, respectively. We summarize the generative model as follows:

### Generative Model:

For the Group G, choose qG from the Gamma distribution with parameters scale and shape, and, choose kG from a Pareto distribution with parameters threshold and exponent.
Within the group messages arrive sequentially, and when a message u arrives, it gets attached to v using the TI-model of.
The timestamp of u, t(u) is chosen such that t(u)−t(v) is a q-exponential random variable with parameter qG and kG, i.e.,

$$Pr [ t ( u ) - ( v ) \geq x ] = {( 1 - \frac{( 1 - {q}_{G} ) x}{{κ}_{G}} )}^{\frac{1}{1 - {q}_{C}}} .$$

A random variable X is q-exponentially distributed with shape and scale parameters q and k, respectively, if its upper cumulative (or complementary) distribution function is Pr[X≧x]=(1−(1−q)x/k)^{1/(1-q)}). We observed that reply time distributions for some of the largest groups and their corresponding q-exponential fits obtained by a Maximum Likelihood estimate correlate very well. In this disclosure, we use q-exponential distribution to model time to reply for individual groups. When a right mix of q-exponentials is accumulated over all individual groups, it is possible to generate an overall distribution close to a power-law.

For example, in a simulation, we first estimate individual group-level q-exponential parameters. We then sampled 1000 points from these parameter distributions and sampled equal number of samples from the distributions governed by these parameters. When samples across all groups are merged, these individual q-exponential distributions give rise to a power law like distribution. However, although the q-exponential give reasonable visual correspondence to data, a stringent Kolmogoro-Smirnov goodness of fit test rejects the hypothesis that the distributions are the same. Thus, q-exponential is only an approximation.

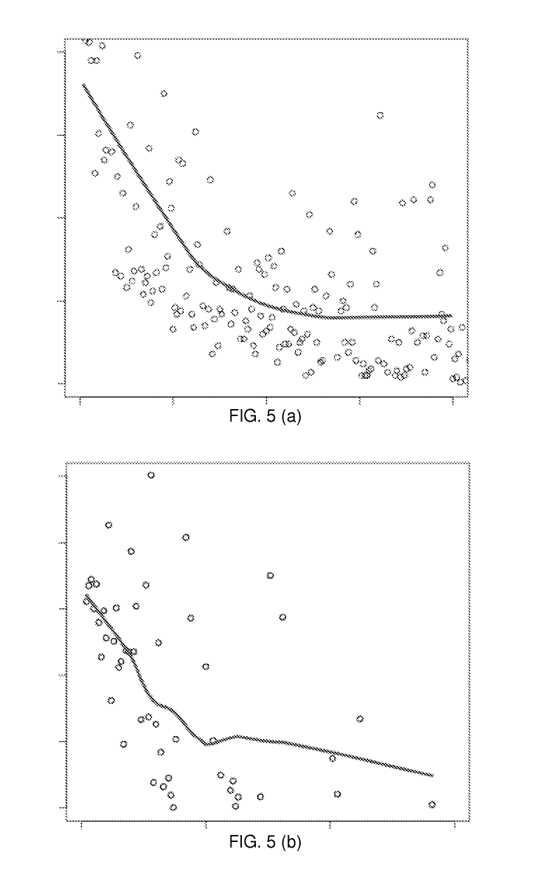

FIG. 5 illustrates the average time to first reply to a root message vs. thread size. Here the time to first reply to the root message is the time delay between the timestamps of the first reply message and the root message. The time to first reply may also be denoted as first reply time. In FIG. 5, the horizontal axis represents the thread size, and the vertical axis represents the mean first reply times. The solid curve represents Locally Weighted Scatterplot Smoothing (LOWESS) smoothing over all threads in a group or all the groups. Generally, first replies to the root message arrive much quicker for threads that grow to receive many replies. This is true within a group (e.g., FIGS. 5(a) and 5(b) show the two biggest groups), as well as aggregated over all the groups (FIG. 5(c)). This suggests that popular threads usually are popular from the start, and begin receiving quicker replies right from the time the root message is posted. In other words, the root message content or the identity of its author determines, to a large extent, the eventual success of a thread.

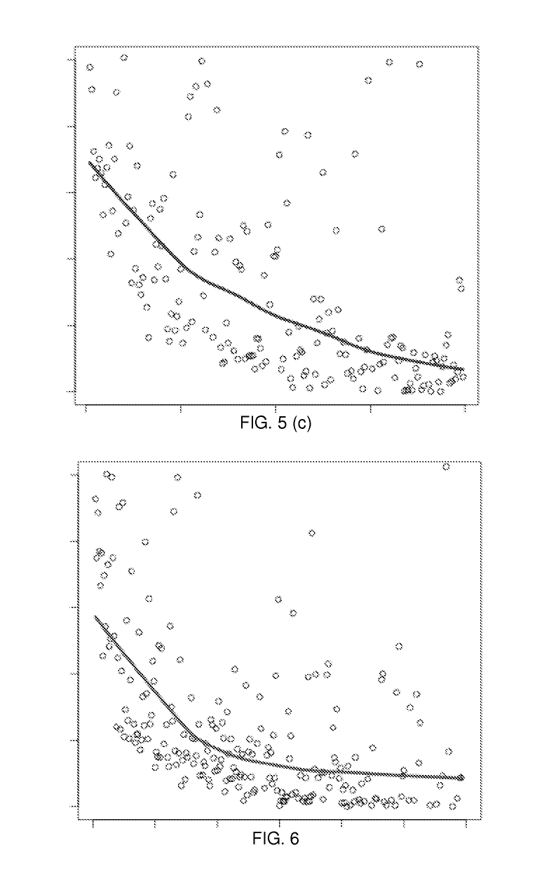

FIG. 6 illustrates how messages with higher degree also generally have quicker first reply times. In FIG. 6, the horizontal axis represents the degree of thread, and the vertical axis represents the mean first reply times. The solid curve represents LOWESS smoothing over all threads in all the groups. This confirms that if a message receives a quick first reply, then probably it is interesting enough to receive many more subsequent replies.

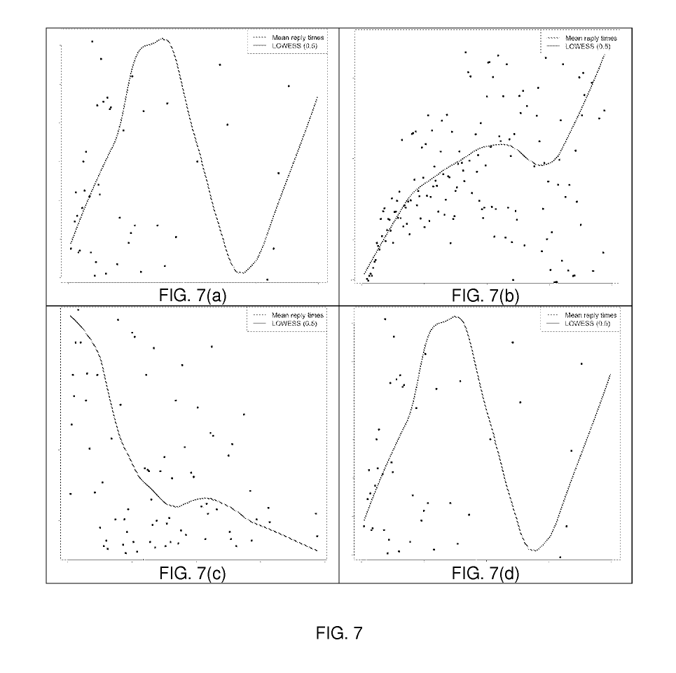

FIG. 7 illustrates the relationship between the mean reply time and thread size. In FIG. 7, the horizontal axis represents the thread size, and the vertical axis represents the mean reply times. While time to first reply to the root message correlates well with the eventual thread size, the average delay over all replies to a message, on the other hand, paints a different picture. For many groups, we in fact see an increase in the mean reply time with thread size (see FIGS. 7(a), 7(b)). This is due to the fact that many big threads have long pauses in between, i.e., they become in-active for a while and then they again become active. We also see that for some groups, the mean reply time oscillates unpredictably as the thread size grows (see FIG. 7(d)). We looked at a large number of threads but found no systematic pattern in thread size vs. mean times to reply.

In summary, we showed how times to reply for individual groups resemble q-exponential distributions, which may in turn arise from individual exponentially distributed times to reply. While analyzing growth of individual threads, we showed how the first reply to a root message is a good predictor of how popular the thread will go on to be, and showed social and individual correlates that implicate the originator of messages and not the replier as a more prominent driver of thread growth. Finally, we created a generative model to capture times to reply.

The disclosed computer implemented method may be stored in computer-readable storage medium. The computer-readable storage medium is accessible to at least one processor such as a CPU. The processor is configured to implement the stored instructions to suggest a thread in an online group accordingly.

From the foregoing, it can be seen that the present embodiments provide a novel solution to suggest threads to a user in an online group. The disclosed embodiments find the appropriate threads by considering the different social properties of the user and the first author. Although the examples are about suggesting a thread in an online group, the disclosed methods and systems may be used to suggest other information in a social network, an online game platform, or other online websites with social interactivity.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for suggesting a thread (T) in an online group, comprising:
calculating an average in-reply time to each user in the online group on history data;
calculating an average out-reply time from each user in the online group on history data;
identifying, in a computer system, a root message in the thread (T) by a first author;
identifying, in the computer system, a second message in the thread (T) that follows the root message;
determining, in the computer system, an estimated growth rate of the thread (T) based on average in-reply time and average out-reply time of the first author and a time delay between the second message and the root message; and
suggesting the thread (T) to users in the online group according to the estimated growth rate of the thread (T).

2. The method of claim 1 further comprising: determining, for a user in the online group, a likelihood of joining the thread (T) based on a plurality of social properties and a plurality of online behavior of the user.

3. The method of claim 1 further comprising: determining, for an author in the thread (T), a likelihood of increase or decrease in activity based on a first plurality of social properties of the author and a second plurality of social properties of an author of a parent message.

4. The method of claim 1 further comprising: updating, for a user (a) in the online group, a social graph of the user (a) at a predetermined time interval, wherein the social graph comprises a plurality of vertices representing a plurality of users of the online group.

5. The method of claim 4, wherein the social graph at time (t) comprises an edge between the user (a) and a second user (v), an edge weight of the edge representing a number of times the second user (v) replied to the user till time (t).

6. The method of claim 5, wherein the plurality of social properties of a user (a) comprises at least one of the following:
degree(a) that relates to the total number of replies by the user (a),
social_degree(a, T) that relates to the total number of replies by the user (a) in the thread (T),
no_of_neighbors(a,T) that relates to the number of neighbors of the user (a) in the thread (T),
thread_size(T) that relates to the number of messages in the thread (T), and
weight_last_author(a, T) that relates to an edge between the user (a) and the author who posted the last message in the thread (T).

7. The method of claim 6, further comprising: calculating at least one of the following social variables based on the social graph at time (t) for thread (T):
weight_last_author(a, T) equals an edge weight of the edge between the user (a) and an author who posted the last message in the thread T;
degree(a) equals total number of replies by the user (a) in the online group;
social_degree(a, T) equals total number of replies by the user (a) to all authors currently present in the thread (T);
no_of_neighbors(a,T) equals number of authors present in the thread (T) that the user (a) has replied at least once in the past; and
thread_size(T) equals total number of messages in the thread.

8. The method of claim 6, further comprising:
fitting a first regression for a probability of a return of the user (a) to thread (T) based on the plurality of social properties of the user (a), and
fitting a second regression for a probability of an increase or decrease in activity of the user (a) to thread (T) based on the plurality of social properties of the user (a) and a social property of a parent author.

9. The method of claim 8, wherein the social property of the parent author comprises a ratio of the parent author's mean in-reply time to the parent author's mean out-reply time.

10. A computer-readable storage medium storing a set of instructions for suggesting a thread (T) in an online group, the set of instructions to direct a processor to:
calculate an average in-reply time to each user in the online group on history data;
calculate an average out-reply time from each user in the online group on history data;
identify a root message in the thread (T) by a first author;
identify a second message in the thread (T) that follows the root message;
determine a growth rate of the thread (T) based on average in-reply time and average out-reply time of the first author and a time delay between the second message and the root message;
determine, for a user in the online group, a likelihood of joining the thread (T) based on a plurality of social properties of the user; and
determine whether to suggest the thread (T) to the user according to the estimated growth rate of the thread (T) and the likelihood of joining the thread (T).

11. The storage medium of claim 10, wherein the set of instructions directs the processor to determine, for an author in the thread (T), a likelihood of increase or decrease in activity based on a first plurality of social properties of the author and a second plurality of social properties of an author of a parent message.

12. The storage medium of claim 10, wherein the set of instructions directs the processor to update, for a user (a) in the online group, a social graph of the user (a) at a predetermined time interval.

13. The storage medium of claim 12, wherein the social graph comprises a plurality of vertices representing a plurality of users of the online group.

14. The storage medium of claim 13, wherein the social graph at time (t) comprises an edge between the user (a) and a second user (v), an edge weight of the edge representing a number of times the second user (v) replied to the user till time (t).

15. The storage medium of claim 14, wherein the set of instructions directs the processor to calculate at least one of the following social variables based on the social graph at time (t) for thread (T):
weight_last_author(a, T) equals an edge weight of the edge between the user (a) and an author who posted the last message in the thread T;
degree(a) equals total number of replies by the user (a) in the online group;
social_degree(a, T) equals total number of replies by the user (a) to all authors currently present in the thread (T);
no_of_neighbors(a,T) equals number of authors present in the thread (T) that the user (a) has replied at least once in the past; and
thread_size(T) equals total number of messages in the thread.

16. The storage medium of claim 15, wherein the set of instructions directs the processor to fit a first regression for a probability of a return of the user (a) to thread (T) based on the plurality of social properties of the user (a).

17. The storage medium of claim 16, wherein the set of instructions directs the processor to fit a second regression for a probability of an increase or decrease in activity of the user (a) to thread (T) based on the plurality of social properties of the user (a) and a social property of a parent author.

18. The storage medium of claim 17, wherein the social property of the parent author comprises a ratio of the parent author's mean in-reply time to the parent author's mean out-reply time.

19. A computer system comprising:
a processor configured to fit a first regression for a probability of an return of a user (a) to thread (T) based on a plurality of social properties of the user (a) and fit a second regression for a probability of an increase or decrease in activity of the user (a) to thread (T) based on the plurality of social properties of the user (a) and a social property of a parent author,
wherein the processor determines a likelihood of joining the thread (T) based on the first regression,
wherein the processor determines a growth rate of the thread (T) based on the second regression, and
wherein the processor suggests the thread (T) to users in the online group according to the estimated likelihood of joining and growth rate of the thread (T).

20. The system of claim 19, wherein the plurality of social properties of the user (a) comprises at least one of the following social variables based on the social graph at time (t) for thread (T):
weight_last_author(a, T) equals an edge weight of the edge between the user (a) and an author who posted the last message in the thread T;
degree(a) equals total number of replies by the user (a) in the online group;
social_degree(a, T) equals total number of replies by the user (a) to all authors currently present in the thread (T);
no_of_neighbors(a,T) equals number of authors present in the thread (T) that the user (a) has replied at least once in the past; and
thread_size(T) equals total number of messages in the thread.
